(19) United States
(12) Patent Application Publication
(10) Pub. No.: US 2007/0221799 A1
(43) Pub. Date: Sep. 27, 2007

(54) Table leveler

(76) Inventor: Mark A. Hurley, Reisterstown, MD (US)

Correspondence Address: SUNG I. OH, PROFESSIONAL LAW CORPORATION, 710 QUAIL VALLEY LANE, WEST COVINA, CA, 91791, US

(21) Appl. No.: 11/386,433

(22) Filed: Mar. 22, 2006

(51) Int. Cl. F16M 11/24

(52) U.S. Cl. 248/188.2

(57) ABSTRACT

A device for leveling furniture includes two portions that are movably connected together by a connecting portion. Teeth are located on each of the two portions and a spacing element is inserted between the two portions to establish a spacing between the two portions. Furniture supported on the device can thus be leveled by moving the supporting element of the furniture, such as a table leg, up or down with respect to a supporting surface, such as the floor or the ground, by adjusting the spacing between the two portions of the device using the spacing element. The spacing is secure because the spacing element is securely held in the teeth of the device.

### TECHNICAL FIELD OF THE INVENTION

The present invention relates to the general art of furniture accessories, and to the particular field of devices used to level furniture.

### BACKGROUND OF THE INVENTION

Most articles of furniture are constructed to have a lower support structure which defines a support plane at its lowermost points. The operative or working areas of the article of furniture is then oriented in a desired manner with respect to that support plane by the support structure. For example, a typical table has a horizontal dining surface which is oriented parallel to the floor and which is supported by four downwardly depending legs. Thus, the support plane of this table is the plane defined by the free ends of the legs. However, planar geometry dictates that only three operative support points define a plane. Thus, it is necessary that the table legs be sized with great care in order to ensure that all four free ends terminate in a common plane; otherwise, the table will have instability.

Most articles of furniture are usually supported by lower support members which indeed have a number of potential support points in excess of three. These include, by way of example, articles of furniture, such as the table, above, which have four or more downwardly depending legs, articles which have horizontal runners adapted to abut the support surface and pedestal supported articles. Unless special care is taken, it is often possible that the lower support structure of these articles does not terminate in a common support plane. When this happens, the article of furniture does not have a single stable support plane but rather is subject to unwanted wobbling or tipping. Accordingly, many tables have a seemingly ever-present wobble that causes constant irritation. Such wobbling generally results from equal table legs on an uneven floor. Even such articles of furniture which have only three support points, such as a three legged table, that automatically define a stable support plane, it still occurs that the working surface may not be in a desired orientation due to any error in the intended length of any support.

In restaurants, in particular, wobbly tables are a problem both as an annoyance for customers and as a detraction from the table's function of supporting dinnerware and other articles on it. The same problem exists with patio furniture. Whether floors are made of wood, tile, concrete, terrazzo, or any other material, the floor surface is seldom perfectly flat. For this purpose, the legs or pedestals of many tables are provided with glides which are typically mounted by screw threads to enable the glides to be vertically adjusted for stable support of the table on floor surfaces which are not perfectly level. The difficulty with conventional table glides is that it is a time consuming process to properly adjust them. In a busy restaurant setting, time is simply not available to make such adjustments each time a table is moved. Such adjustments would likely require that the table be tipped up or turned down on its side for access to the glide with a tool if necessary. Accordingly, such adjustments may be an unacceptable disruption in any event. Finally, even if the table glides are properly adjusted once, readjustment would be necessary each time the table is moved to accommodate combining tables or different table arrangements.

Even on level surfaces, adjustment may be necessary when combining tables to level them relative to one another. When two tables are moved together, they not only need to be stabilized at that new position, but also leveled with one another to eliminate a ledge at the joint since it may be necessary for a patron to be seated at the junction where two tables meet.

Accordingly, there has been a long-felt need for mechanical structures and devices which can level or otherwise stabilize articles of furniture. To this end, some articles of furniture are provided with adjustable pads on their lower supports with these pads typically being threaded bolts which terminate in support pads or heads. These threaded bolts move into and out of the lower supports to define an adjustable support plane. Thus, the support pads may be threadably adjusted so that all of the common support points are in a common plane. Other techniques of leveling items such as heavy machinery include the use of a pair of freely sliding wedges which are innerconnected by means of a threaded shaft; a torque applying assembly interconnects the wedges so that they may be forcibly slid with respect to one another to provide vertically adjustable supports for the machine.

Despite the existence of different leveling structures, it is still a common experience for a person to find an article of furniture, such as a table and the like, which is either not level or is not stabilized. Such inconvenient event happens commonly in restaurants, taverns and other places of social gathering. One possible reason for this inconvenience includes the fact that the majority of articles of furniture do not include any adjustable stabling structure whatsoever despite the fact of the known use of adjustable pads; this omission is possibly due to the increased cost. Even where leveling structures are present on the article of furniture they may be out of adjustment or may have been damaged through intense use. Sometimes the integrity of the support structure has, itself, been compromised through use. Hence, many persons at one time or another have found themselves utilizing an article of furniture which is unstable or is otherwise off level. This situation can jeopardize the use of the article and, indeed, the persons situated therearound, since the food items, drinks and the like can become spilled or otherwise compromised during use of the article. Further, the wobbling of a table is often very annoying for people sitting therearound since each time a person contacts the table, the table may shift.

In order to help stabilize tables and other articles of furniture, then, it is a common practice for persons in restaurants and taverns to try to use napkins, matchbook covers, coins and other devices in a vain attempt to stabilize a table or other furniture article. Accordingly, there is a need on the part of business proprietors for a simple and inexpensive device which can be used to level tables or other furniture articles in their establishments and a need for a simple, inexpensive portable device which a person may conveniently carry in his/her pocket in order to stabilize a table.

While the inventor is aware of several leveling wedges that can be used to stabilize an article of furniture, these leveling devices are generally inconvenient to use and are not easily adjusted to account for varying degrees of unevenness. Therefore, there is a need for a device that can be used to level an article of furniture that is easily adjusted whereby a great range of unevenness can be accommodated with a single leveling device.

### SUMMARY OF THE INVENTION

The above-discussed disadvantages of the prior art are overcome by a device that levels furniture, such as tables, and which includes a multi-part body that has two portions that are hingeably attached to a connecting portion and which are spaced apart by a gap which is a function of the angles established between the two portions and the connecting portion. A spacing element is interposed between the two portions and is attached to the two portions via teeth on each of the two portions. The teeth have varying thicknesses so the spacing between the two portions can be varied according to where the spacing element is located while the two portions remain parallel to each other.

Using the device embodying the present invention will permit a user to quickly and easily level an article of furniture while stably and securely maintaining the leveled condition.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a device for leveling furniture embodying the present invention in a use condition.

FIG. 2 is a side elevational view taken along line 2-2 of FIG. 1.

FIG. 3 is a top plan view of the device shown in FIG. 1.

FIG. 4 is a sketch showing the teeth of the device having thicknesses which vary from the teeth located adjacent to one end of the device to the teeth located adjacent to a second end of the device.

### DETAILED DESCRIPTION OF THE INVENTION

Referring to the figures, it can be understood that the present invention is embodied in a device 10 for leveling furniture, such as tables, chairs or the like.

Device 10 comprises a multi-part body 12 which is placed beneath the support element of furniture, such as beneath a leg of a table to level that furniture.

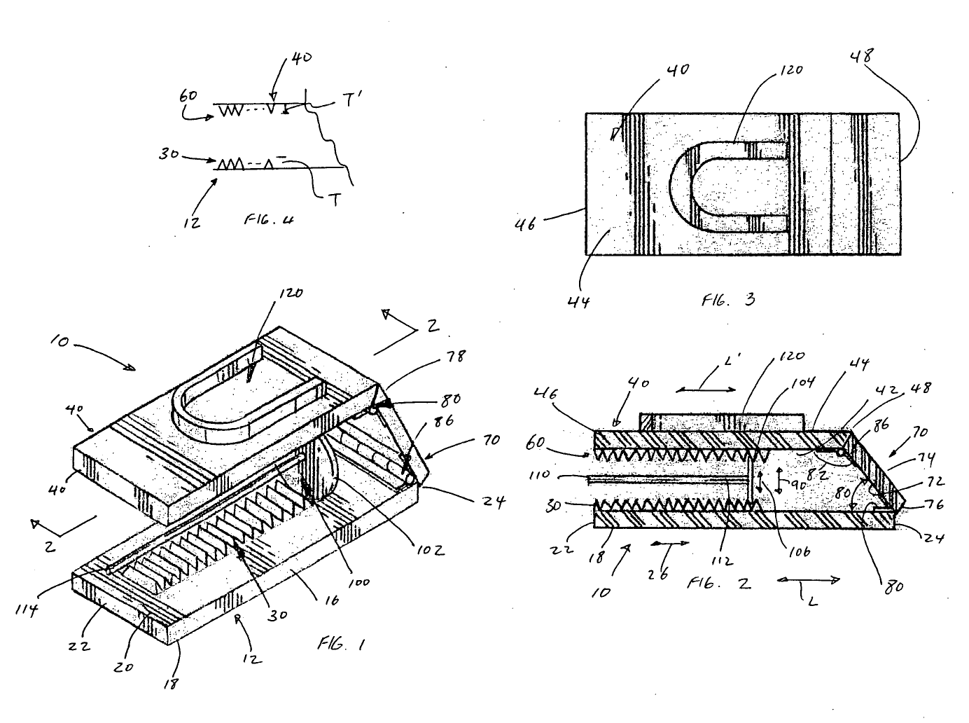

Body 12 includes a first portion 16 that is a bottom portion when the body is in a use orientation beneath the furniture, with a use orientation being shown in FIG. 1. First portion 16 has a first surface 18 that is a bottom surface and which rests on a support surface such as a floor when the body is in the use orientation, a second surface 20 which is an upper surface when the body is in the use orientation, a first end 22, a second end 24 and a longitudinal axis 26 which extends between the first end and the second end.

A plurality of teeth 30 are located on second surface 20 and are spaced apart in the direction of longitudinal axis 26 and extend from adjacent to first end 22 to adjacent to second end 24. As can be understood from FIG. 4, the teeth on the first portion have a thickness dimension T which is measured from second surface 20 of the first portion. The thickness of the teeth on the first portion changes from adjacent to the first end of the first portion to adjacent to the second end of the first portion for a purpose that will be understood from the teaching of this disclosure. First portion 12 also has a length dimension L that is measured in the direction of longitudinal axis 26 from first end 22 to second end 24.

Multi-part body 12 further comprises a second portion 40 that is a top portion when the body is in a use orientation. Second portion 40 has a first surface 42 that is a bottom surface when the body is in the use orientation, a second surface 44 which is an upper surface when the body is in the use orientation, a first end 46, a second end 48 and a longitudinal axis 50 which extends between first end 46 second end 48.

A plurality of teeth 60 are located on first surface 42 of the second portion and are spaced apart in the direction of longitudinal axis 50 of the second portion and extend from adjacent to first end 46 to adjacent to second end 48 of the second portion. As can be understood from FIG. 4, teeth 60 have a thickness dimension T′ measured from first surface 42 of the second portion. Thickness dimension T′ of teeth 60 changes from adjacent to first end 46 to adjacent to second end 48 of the second portion.

Second portion 40 has a length dimension L′ that is measured in the direction of longitudinal axis 50 of the second portion from first end 46 to second end 48 of the second portion. Length dimension L′ of the second portion is shorter than length dimension L of the first portion. First portion 12 is oriented to be parallel to and spaced apart from second portion 40 in the use orientation of the body with teeth 30 of the first portion located to be parallel to and spaced apart from teeth 60 of the second portion 40.

Device 10 further comprises a connecting portion 70 which movably connects first portion 12 to second portion 40 and maintains these two portions in parallel relationship with each other while permitting the spacing between the two portions to change in order to raise or lower furniture supported on device 10.

Connecting portion 70 includes a first surface 72 that is an inside surface which is located adjacent to the first surface of the first portion and the second surface of the second portion when the body is in the use orientation, and a second surface 74 that is an outside surface when the body is in the use orientation. Connecting portion 70 further includes a first end 76 which is located adjacent to second end 24 of first portion 12 when the body is in the use orientation and a second end 78 which is located adjacent to second end 48 of second portion 40 of the body when the body is in the use orientation.

A first hinge 80 hingeably connects first end 76 of connecting portion 70 to second end 24 of first portion 12 of the body and a first angle 81 is defined between first surface 72 of the connecting section and second surface 20 of first portion 12. A second angle 82 is defined between first surface 72 of the connecting section and first surface 42 of second section 40. A second hinge 86 hingeably connects second end 78 of the connecting portion to second end 48 of second portion 40 of the body.

A spacing gap 90 is defined between second surface 20 of the first portion of the body and first surface 42 of the second portion of the body. Spacing gap 90 has a length dimension that is measured between the second surface of the first portion of the body and the first surface of the second portion of the body which is a function of size of the first and second angles.

A spacing gap setting element 100 is interposed between the teeth on the first portion and the teeth on the second portion to set the distance between the first and second portions and thereby set the distance the furniture is displaced from the support surface, such as a floor to level that furniture. Element 100 includes a plate 102 which has a peripheral edge 104 and a dimension 106 which is measured between two spaced apart points on the peripheral edge. In the form shown in FIGS. 1 and 2, plate 102 is circular; therefore, dimension 106 is a diameter of the plate. Plate 102 is inserted between teeth 30 on the first portion of the body and teeth 60 on the second portion of the body to separate the first portion of the body from the second portion of the body and to adjust the first and second angles and thereby adjust the length dimension of the spacing gap while maintaining the first and second portions of the body in parallel relationship to each other.

A handle 110 has a first end 112 connected to the plate and a second end 114 which extends out of the spacing gap when the plate is inserted between the teeth of the first portion and the teeth of the second portion. The handle is grasped to move the plate within the spacing gap to set the distance of separation between the first and second portions, with the connecting portion moving to maintain the two portions parallel to each other for each spacing. A furniture support element 120 is located on second surface 44 of second portion 40 and accommodates the furniture, such as the bottom end of a table leg. This will securely support the furniture on device 10.

As can be understood from the teaching of this disclosure, the hinged connection between the connecting portion and the first and second portions and the varying thickness of the teeth will maintain device 10 in the form of a polygon with a varying spacing between the top and bottom portions which remain parallel with each other no matter what the spacing therebetween. Insertion and removal of device 100 affects this varying spacing and once selected, the spacing will remain secure because plate 102 will remain securely in place due to its engagement with teeth 30 and 60. Device 100 is inserted between portions 12 and 40 until the desired pacing is established between the two portions to level the furniture supported on device 10.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A device for leveling furniture comprising:
A) a multi-part body which includes
(1) a first portion that is a bottom portion when the body is in a use orientation, the first portion having
(a) a first surface that is a bottom surface and which rests on a support surface such as a floor when the body is in the use orientation,
(b) a second surface which is an upper surface when the body is in the use orientation,
(c) a first end,
(d) a second end,
(e) a longitudinal axis which extends between the first end and the second end,
(f) a plurality of teeth located on the second surface and which are spaced apart in the direction of the longitudinal axis and which extend from adjacent to the first end to adjacent to the second end, the teeth on the first portion having a thickness dimension measured from the second surface of the first portion, the thickness of the teeth on the first portion changing from adjacent to the first end of the first portion to adjacent to the second end of the first portion, and
(g) a length dimension that is measured in the direction of the longitudinal axis from the first end to the second end,
(2) a second portion that is a top portion when the body is in a use orientation, the second portion having
(a) a first surface that is a bottom surface when the body is in the use orientation,
(b) a second surface which is an upper surface when the body is in the use orientation,
(c) a first end,
(d) a second end,
(e) a longitudinal axis which extends between the first end of the second portion and the second end of the second portion,
(f) a plurality of teeth located on the first surface of the second portion and which are spaced apart in the direction of the longitudinal axis of the second portion and which extend from adjacent to the first end of the second portion to adjacent to the second end of the second portion, the teeth on the second portion having a thickness dimension measured from the first surface of the second portion, the thickness of the teeth on the second portion changing from adjacent to the first end of the second portion to adjacent to the second end of the second portion,
(g) a length dimension that is measured in the direction of the longitudinal axis of the second portion from the first end of the second portion to the second end of the second portion, the length dimension of the second portion being shorter than the length dimension of the first portion, and
(h) the first portion being oriented to be parallel to and spaced apart from the second portion in the use orientation of the body with the teeth of the first portion being located to be parallel to and spaced apart from the teeth of the second portion, and
(3) a connecting portion which includes
(a) a first surface that is an inside surface which is located adjacent to the first surface of the first portion and the second surface of the second portion when the body is in the use orientation,
(b) a second surface that is an outside surface when the body is in the use orientation,
(c) a first end which is located adjacent to the second end of the first portion of the body when the body is in the use orientation,
(d) a second end which is located adjacent to the second end of the second portion of the body when the body is in the use orientation,
(4) a first hinge hingeably connecting the first end of the connecting portion to the second end of the first portion of the body,
(5) a first angle located between the first surface of the connecting section and the second surface of the first portion,
(6) a second angle located between the first surface of the connecting section and the first surface of the second section, and
(7) a second hinge hingeably connecting the second end of the connecting portion to the second end of the second portion of the body;
B) a spacing gap defined between the second surface of the first portion of the body and the first surface of the second portion of the body, the spacing gap having a length dimension that is measured between the second surface of the first portion of the body and the first surface of the second portion of the body, the length dimension of the spacing gap being a function of size of the first and second angles;
C) a spacing gap setting element which is interposed between the teeth on the first portion and the teeth on the second portion and which includes
(1) a plate having a peripheral edge and a dimension measured between two spaced apart points on the peripheral edge, the plate being inserted between the teeth on the first portion of the body and the teeth on the second portion of the body to separate the first portion of the body from the second portion of the body and to adjust the first and second angles and thereby adjust the length dimension of the spacing gap while maintaining the first and second portions of the body in parallel relationship to each other, and
(2) a handle having a first end connected to the plate and a second end which extends out of the spacing gap when the plate is inserted between the teeth of the first portion and the teeth of the second portion; and
D) a furniture support element on the second surface of the second portion.

2. A device for leveling furniture comprising:
A) two planar portions;
B) a connecting portion movably connected to each planar portion to movably connect the two planar portions together,
C) a plurality of teeth on each planar portion;
D) a spacing gap setting element which is interposed between the two planar portions in use and which is held in position by the teeth, the location of the spacing gap setting element with respect to the two planar portions setting a gap between the two planar portions with the size of the gap being a function of the location of the spacing gap setting element with respect to the two planar portions and with respect to the connecting portion; and
E) the planar portions and the teeth and the connecting portion being arranged with respect to each other so the planar portions remain parallel to each other no matter where the spacing gap setting element is located between the two planar portions and no matter what the size of the gap.
